(19) United States
(12) Patent Application Publication
(10) Pub. No.: US 2025/0269646 A1
(43) Pub. Date: Aug. 28, 2025

(54) LIQUID JET HEAD AND LIQUID JET RECORDING APPARATUS

(71) Applicant: SII Printeck Inc., Chiba-shi (JP)

(72) Inventor: Takanori KOYANO, Chiba-shi (JP)

(21) Appl. No.: 19/048,659

(22) Filed: Feb. 7, 2025

(30) Foreign Application Priority Data
Feb. 26, 2024 (JP) 2024-026438

(51) Int. Cl. B41J 2/14

(52) U.S. Cl. CPC B41J 2/14427; B41J 2002/14443; B41J 2002/14491

(57) ABSTRACT

Damage of a liquid jet head from static electricity is prevented. The liquid jet head according to an aspect of the present disclosure includes a base member, a jet module mounted on the base member, and configured to jet a liquid, a nozzle plate provided with a nozzle hole configured to jet the liquid, a nozzle guard made of metal and configured to protect the nozzle plate, and a conductive part which has conductivity, is electrically coupled to the jet module and the nozzle guard via the base member, and is configured to couple the nozzle guard to a frame ground.

### RELATED APPLICATIONS

This application claims priority to Japanese Patent application No. JP2024-026438, filed on Feb. 26, 2024, the entire content of which is incorporated herein by reference.

### BACKGROUND OF THE INVENTION

### 1. Field of the Invention

An embodiment of the present disclosure relates to a liquid jet head and a liquid jet recording apparatus.

### 2. Description of the Related Art

JP2004-74676A (PTL1) discloses a nozzle for jetting a liquid, a flow path unit, communicating to the nozzle, for forming a pressure generating chamber to change pressure with a drive unit, and a liquid jet head which makes the flow path unit have contact with a head case to protect the flow path unit with a head cover. The head cover is formed of, for example, metal having conductivity.

However, when a cover component for protecting a nozzle plate is made of metal having conductivity, and is not electrically coupled to other components, there is a high possibility that the static electricity from a medium hits an electrode or the like through a nozzle hole. Therefore, there is a high possibility that damage of the liquid jet head from the static electricity occurs.

The present disclosure is made in view of the problem described above, and has an object of preventing the damage of the liquid jet head from the static electricity.

### SUMMARY OF THE INVENTION

(1) A liquid jet head according to an aspect of the present disclosure includes a base member, a jet module mounted on the base member, and configured to jet a liquid, a nozzle plate provided with a nozzle hole configured to jet the liquid, a nozzle guard made of metal and configured to protect the nozzle plate, and a conductive part which has conductivity, is electrically coupled to the jet module and the nozzle guard via the base member, and is configured to couple the nozzle guard to a frame ground.

According to the liquid jet head related to the present aspect, it is possible to short the nozzle guard to make the nozzle guard the same in potential as the frame ground (hereinafter also referred to as “FG”) so as to prevent the static electricity from the medium from hitting the electrode and so on through the nozzle hole. Therefore, damage of the liquid jet head from the static electricity can be prevented.

(2) In the liquid jet head according to the aspect (1), the conductive part may be fixed outside the jet module.

According to this configuration, the fixation work can be performed outside the jet module, which, therefore, makes a contribution to an improvement of the workability.

(3) In the liquid jet head according to the aspect (2), the conductive part may be fixed on a side surface in a longitudinal direction of the jet module.

According to this configuration, since there is no influence in the thickness direction of the liquid jet head, density growth can be achieved even when disposing a plurality of liquid jet heads in the thickness direction.

(4) In the liquid jet head according to any one of the aspects (1) to (3), the conductive part may be fixed with a screw.

According to this configuration, since screw fixation is adopted, the electrical coupling can more reliably be achieved.

(5) In the liquid jet head according to any one of the aspects (1) to (4), the conductive part may be fixed to a same member as a grounded portion of a drive board for the jet module.

According to this configuration, the potential can reliably be made the same as that of the drive board without intervention of any other members due to the commonalization of the grounded portion. In addition, noise suppression effect is obtained.

(6) In the liquid jet head according to any one of the aspects (1) to (5), the base member may be provided with an opening part through which the conductive part passes.

According to this configuration, the jet module and the nozzle guard can electrically be coupled through the opening part of the base member, which, therefore, makes a contribution to shortening of the conduction path. Further, even when the base member is partially made of a nonmetallic material, the nozzle guard can be made the same in potential as FG.

(7) In the liquid jet head according to any one of the aspects (1) to (6), at least a corner portion of the nozzle guard may include a drawn part to which drawing processing is applied.

According to this configuration, it is possible to prevent a gap from being formed in at least the corner portion of the nozzle guard.

(8) In the liquid jet head according to the aspect (7), a side surface portion of the nozzle guard may have a bent part to which bending processing is applied.

According to this configuration, even the portion which cannot be provided with enough length by the drawing processing alone can be stretched long enough by the bending processing, and therefore, it becomes possible to achieve the conduction with the side surface portion.

(9) In the liquid jet head according to the aspect (8), a cutout may be formed on a boundary between the drawn part and the bent part of the nozzle guard.

According to this configuration, it is possible to discharge the liquid which has entered the drawn part through the cutout of the nozzle guard. In addition, even when the nozzle guard is made by the hybrid processing of the drawing processing and the bending processing, the cutout makes the processing easy.

(10) In the liquid jet head according to one of the aspects (8) and (9), the conductive part may be formed of a same member as, and integrally with, the side surface portion of the nozzle guard.

According to this configuration, no dedicated conduction component is required, which makes a contribution to a reduction in the number of components.

(11) In the liquid jet head according to the aspect (10), the conductive part may be fixed outside the jet module in a portion extending straight from the nozzle guard toward above the base member.

According to this configuration, it becomes possible to reduce the space in the installation surface direction compared to when disposing, for the fixation, a widened portion extending in the installation surface direction of the liquid jet head. Further, a housing made of resin can be disposed between the nozzle guard and the base member, which, therefore, makes a contribution to the reduction in cost compared to when disposing a metallic housing.

(12) A liquid jet recording apparatus according to an aspect of the present disclosure includes the liquid jet head according to any one of the aspects (1) to (11).

According to the liquid jet recording apparatus related to the present aspect, it is possible to obtain the liquid jet recording apparatus capable of preventing damage of the liquid jet head from the static electricity.

### BRIEF DESCRIPTION OF THE DRAWINGS

FIG. 1 is a schematic configuration diagram of an inkjet printer according to a first embodiment.

FIG. 2 is a perspective view of an inkjet head according to the first embodiment.

FIG. 3 is a partially exploded perspective view of the inkjet head according to the first embodiment.

FIG. 4 is a perspective view of the inkjet head according to the first embodiment with a part thereof (an FPC unit) exposed.

FIG. 5 is a diagram viewed from the arrow V shown in FIG. 2.

FIG. 6 is a perspective view of a nozzle guard related to the first embodiment.

FIG. 7 is an enlarged view of the boxed portion VII in FIG. 2.

FIG. 8 is a diagram illustrating a conduction path via a base member related to the first embodiment.

FIG. 9 is a diagram illustrating a conduction path sandwiched by a cover and a stay related to the first embodiment.

FIG. 10 is a partially exploded perspective view of an inkjet head according to a second embodiment.

FIG. 11 is a perspective view showing an attachment portion of a stay and a plate member related to the second embodiment.

FIG. 12 is a diagram illustrating a conduction path sandwiched by the plate member and the stay related to the second embodiment.

### DETAILED DESCRIPTION OF THE PREFERRED EMBODIMENTS

Some embodiments according to the present disclosure will hereinafter be described with reference to the drawings. In the embodiments and modified examples hereinafter described, constituents corresponding to each other will be denoted by the same reference symbols to omit the descriptions thereof in some cases. In the following descriptions, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained.

In the following embodiments, the description will be presented citing an inkjet printer (hereinafter referred to simply as a “printer”) for performing recording on a recording target medium using ink (a liquid) as an example of the liquid jet recording apparatus equipped with the liquid jet head according to the present disclosure. The scale size of each member is arbitrarily modified so as to provide a recognizable size to the member in the drawings used in the following description.

### First Embodiment

### Printer

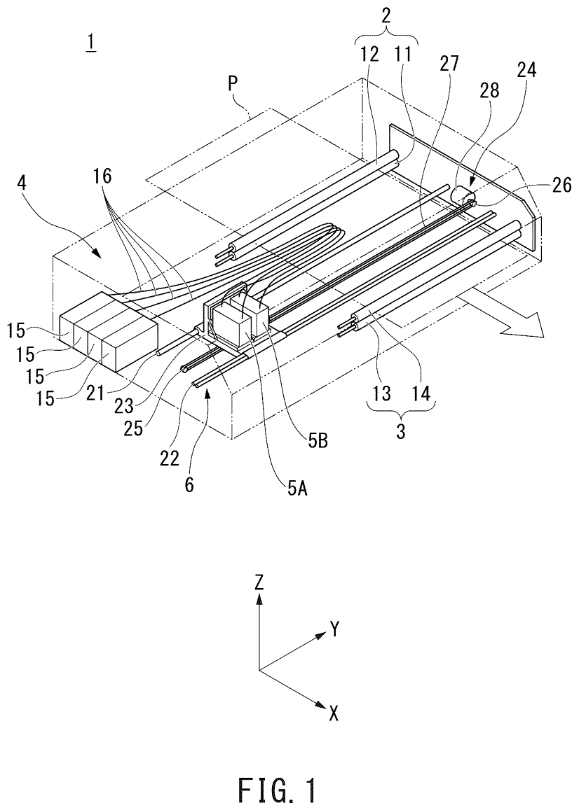

FIG. 1 is a schematic configuration diagram of a printer 1.

As shown in FIG. 1, the printer 1 according to the present embodiment is provided with a pair of conveyance mechanisms 2, 3, an ink supply mechanism 4, inkjet heads 5A, 5B (liquid jet heads), and a scanning mechanism 6.

In the following explanation, the description is presented using an orthogonal coordinate system of X, Y, and Z as needed. The X direction corresponds to a conveyance direction of a recording target medium P (an example of a medium such as paper). The Y direction corresponds to the scanning direction of the scanning mechanism 6. The Z direction corresponds to a vertical direction perpendicular to the X direction and the Y direction. In the following explanation, the description will be presented defining the arrow direction as the positive (+) direction, and a direction opposite to the arrow direction as the negative (−) direction in the drawings in each of the X direction, Y direction, and the Z direction. In the present embodiment, the +Z direction corresponds to an upward direction in the gravitational direction, and the −Z direction corresponds to a downward direction in the gravitational direction.

The conveyance mechanisms 2, 3 convey the recording target medium P in the X direction. Specifically, the conveyance mechanism 2 is provided with a grit roller 11 extending in the Y direction, a pinch roller 12 extending in parallel to the grit roller 11, and a drive mechanism (not shown) such as a motor for making the grit roller 11 make an axial rotation. Similarly, the conveyance mechanism 3 is provided with a grit roller 13 extending in the Y direction, a pinch roller 14 extending in parallel to the grit roller 13, and a drive mechanism (not shown) for making the grit roller 13 make an axial rotation.

The ink supply mechanism 4 is provided with ink tanks 15 each housing the ink, and ink pipes 16 for respectively coupling the ink tanks 15 and the inkjet heads 5A, 5B to each other.

In the present embodiment, the ink tanks 15 are arranged in the X direction. The ink tanks 15 respectively house four colors of ink such as yellow ink, magenta ink, cyan ink, and black ink.

The ink pipes 16 are each, for example, a flexible hose having flexibility. The ink pipes 16 connect the ink tanks 15 and the inkjet heads 5A, 5B to each other, respectively.

The scanning mechanism 6 reciprocates the inkjet heads 5A, 5B in the Y direction. Specifically, the scanning mechanism 6 is provided with a pair of guide rails 21, 22, a carriage 23, and a drive mechanism 24, wherein the pair of guide rails 21, 22 extend in the Y direction, the carriage 23 is movably supported by the pair of guide rails 21, 22, and the drive mechanism 24 moves the carriage 23 in the Y direction.

The drive mechanism 24 is disposed between the guide rails 21, 22 in the X direction. The drive mechanism 24 is provided with a pair of pulleys 25, 26, an endless belt 27, and a drive motor 28, wherein the pair of pulleys 25, 26 are disposed at an interval in the Y direction, the endless belt 27 is wound between the pair of pulleys 25, 26, and the drive motor 28 rotationally drives the pulley 26 as one of the pulleys 25, 26.

The carriage 23 is coupled to the endless belt 27. On the carriage 23, there is mounted the plurality of inkjet heads 5A, 5B in the state of being arranged side by side in the Y direction. The inkjet heads 5A, 5B are arranged so that the two colors of ink can be ejected from each of the inkjet heads 5A, 5B. Therefore, in the printer 1 according to the present embodiment, there is adopted the configuration in which the inkjet heads 5A, 5B each eject the two colors of ink, wherein the two colors of ink ejected by the inkjet head 5A are different from the two colors of ink ejected by the inkjet head 5B, and thus, the four colors of ink, namely the yellow ink, the magenta ink, the cyan ink, and the black ink, can be ejected.

### Inkjet Head

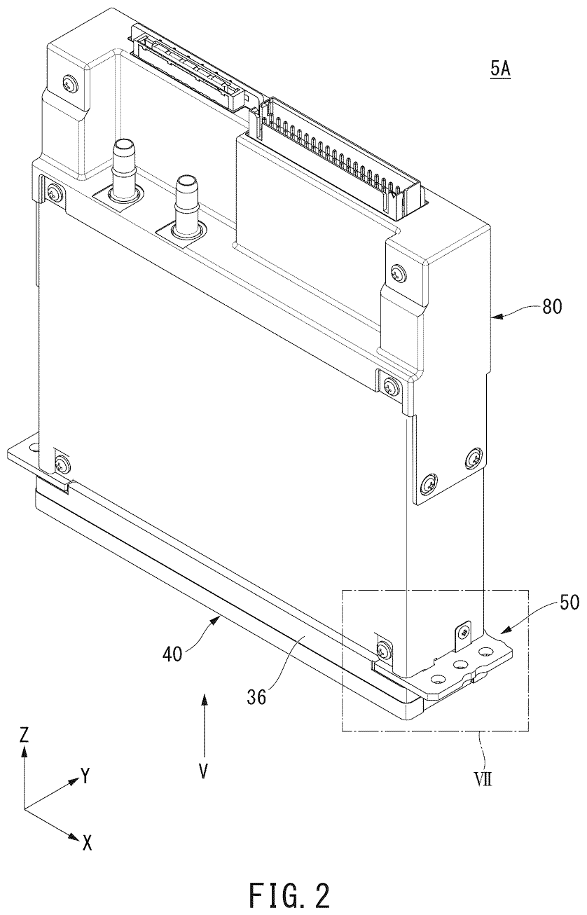

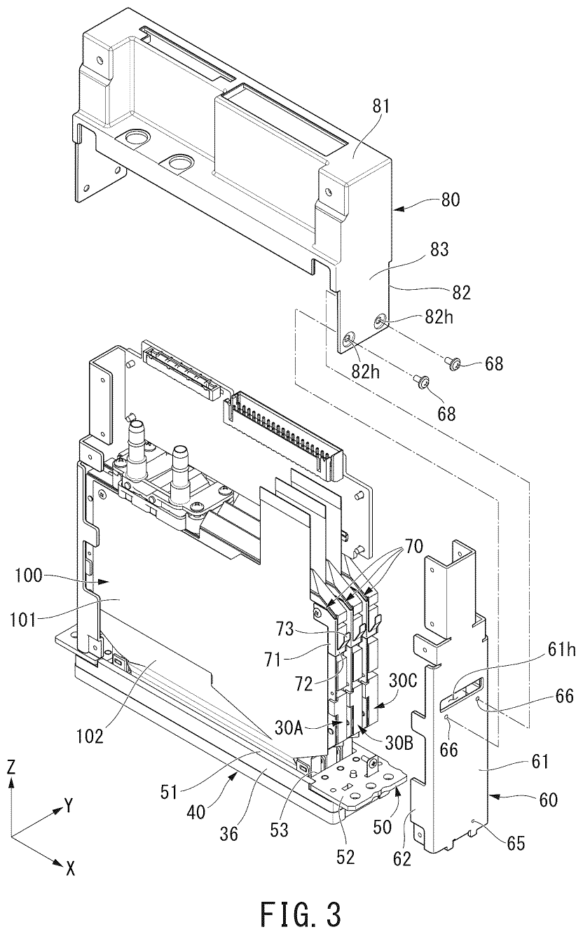

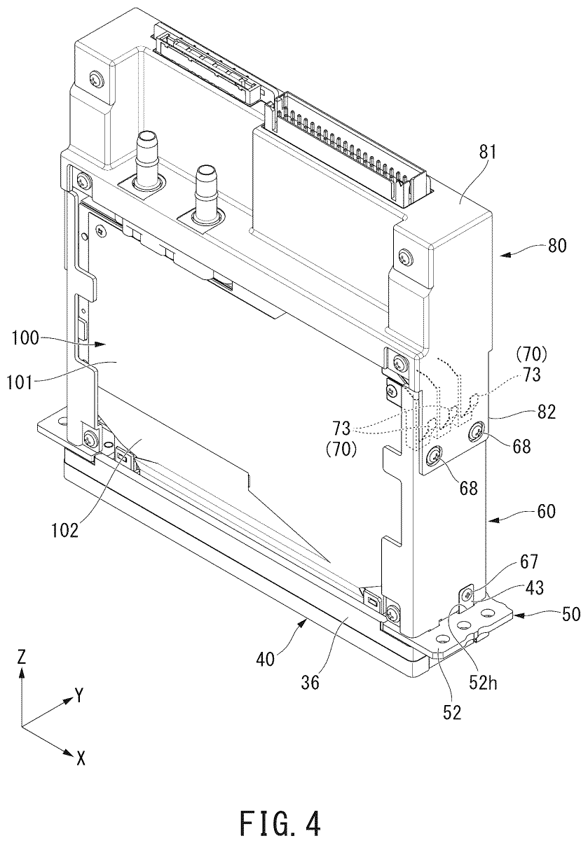

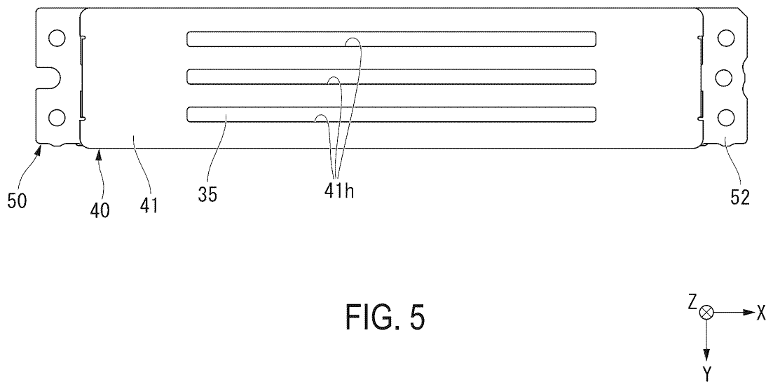

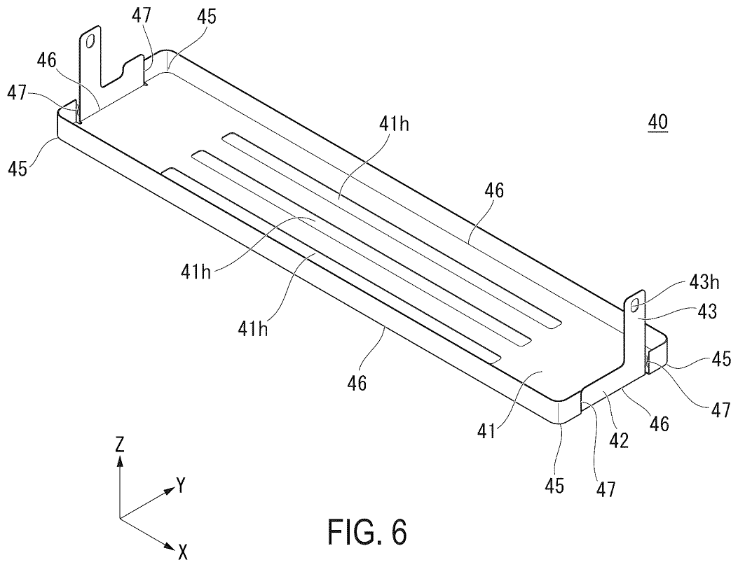

FIG. 2 is a perspective view of the inkjet head 5A. FIG. 3 is a partially exploded perspective view of the inkjet head 5A. FIG. 4 is a perspective view of the inkjet head 5A with a part (an FPC unit 100) thereof exposed. FIG. 5 is a diagram viewed from the arrow V shown in FIG. 2. FIG. 6 is a perspective view of a nozzle guard 40. It should be noted that the inkjet heads 5A, 5B have equivalent configurations except the colors of the ink supplied. Therefore, in the following explanation, the inkjet head 5A will be described, and the description of the inkjet head 5B will be omitted.

The inkjet head 5A according to the present embodiment is an inkjet head of an electromechanical transduction system in which the ink is ejected from a head chip including an actuator plate formed of a piezoelectric element made of PZT (lead zirconate titanate) or the like.

In this inkjet head 5A, in order to eject the ink, a voltage is applied between electrodes on drive walls of an ejection channel provided to the actuator plate to cause the drive wall to make a thickness-shear deformation. Thus, due to a change in volume of the ejection channel, the ink in the ejection channel is ejected through a nozzle hole. It should be noted that an ejection system of the ink is not limited to the electromechanical transduction system described above, and it is possible to adopt a charge control system, a pressure vibration system, an electrothermal transduction system, an electrostatic suction system, and so on.

The charge control system is for providing a charge to a material with a charge electrode to eject the material from a nozzle while controlling a flight direction of the material with a deflection electrode. Further, the pressure vibration system is for applying super high pressure to a material to eject the material toward a nozzle tip, and when a control voltage is not applied, the material goes straight to be ejected from the nozzle, and when the control voltage is applied, an electrostatic repelling force is generated between the materials, and the material flies in all directions to be prevented from being ejected from the nozzle.

Further, the electrothermal transduction system is for rapidly vaporizing a material with a heater provided in a space retaining the material to generate a bubble, to eject the material located in the space with the pressure of the bubble. The electrostatic suction system is for applying minute pressure to a space retaining a material to form a meniscus in the nozzle, applying an electrostatic attractive force in this state, and then pulling the material out. Further, besides the above, it is possible to adopt technologies such as a system using a viscosity alteration of a fluid due to an electric field, or a system of flying a material with a discharge spark.

Referring to FIG. 2 to FIG. 6 in combination, the inkjet head 5A according to the present embodiment is configured with jet modules 30A, 30B, and 30C (see FIG. 3), a nozzle plate 35 (see FIG. 5), the nozzle guard 40 (see FIG. 6), and so on mounted on a base member 50.

### Base Member

The base member 50 is formed to have a shape having a thickness direction set to the Z direction, and a longitudinal direction set to the X direction. The base member 50 includes a base main body part 51 for holding the jet modules 30A, 30B, and 30C, and a carriage fixation part 52 for fixing the base member 50 to the carriage 23 (see FIG. 1). In the present embodiment, the base member 50 is formed as a separated body from a frame body 36. For example, the base member 50 may be formed of a metal material such as stainless steel.

The base main body part 51 is provided with a module housing part 53 which opens in the Z direction so as to be able to house the jet modules 30A, 30B, and 30C. It is arranged that the jet modules 30A, 30B, and 30C can be inserted into the module housing part 53. A −Z-direction end portion of each of the jet modules 30A, 30B, and 30C is arranged to be able to be inserted into the module housing part 53 from the +Z direction side. In this insertion state, the jet modules 30A, 30B, and 30C are each held by the base main body part 51 in a state of standing up toward the +Z direction from the base member 50.

The carriage fixation part 52 projects from a +Z-direction end portion of the base main body part 51 in the X-Y plane. The carriage fixation part 52 more largely projects outward in the X direction than in the Y direction. The carriage fixation part 52 is provided with attachment holes or the like for attaching the base member 50 to the carriage 23 (see FIG. 1).

### Jet Modules

The jet modules 30A, 30B, and 30C are formed to have a plate-like shape having a thickness direction set to the Y direction, and a longitudinal direction set to the X direction. The jet modules 30A, 30B, and 30C are each configured so as to be able to eject the ink supplied from the ink tank 15 (see FIG. 1) toward the recording target medium P. The jet modules 30A, 30B, and 30C are mounted on the base member 50 in a state of being arranged side by side in the Y direction.

In the inkjet head 5A according to the present embodiment, it is arranged that the jet modules 30A, 30B, and 30C are grouped into a single port, and therefore eject ink of a single color. It should be noted that the number of the jet modules 30A, 30B, and 30C mounted on the base member 50, and a color, a type, and so on of the ink to be ejected from the jet modules 30A, 30B, and 30C can be changed as appropriate. The jet modules 30A, 30B, and 30C are each formed of the same configuration, and are mounted on the base member 50 in a state in which the jet modules 30A, 30B, and 30C are arranged side by side in the Y direction.

In the present embodiment, each of the jet modules 30A, 30B, and 30C is of a so-called edge-shoot type which ejects the ink from an end portion (e.g., A −Z-direction end surface of the head chip) in the extending direction (the Z direction) in an ejection channel.

In each of the jet modules 30A, 30B, and 30C, the FPC unit 100 is supported by a surface facing to the −Y direction. The FPC unit 100 is provided with a drive board 101 and a wiring board 102. For example, the drive board 101 and the wiring board 102 are each a flexible printed board, and are each formed of a base film provided with wiring patterns formed thereon. It should be noted that the drive board 101 may be formed of a rigid board or the like in a portion (a mounting portion) on which a driver for driving the head chip is mounted.

The base member 50 is provided with a stay 60 for supporting a component mounted on the base member 50. The stay 60 stands up toward the +Z direction from the base member 50, and at the same time, collectively surrounds the periphery of the jet modules 30A, 30B, and 30C.

### Nozzle Plate

In the present embodiment, the nozzle plate 35 (see FIG. 5) is formed of a resin material such as polyimide. The nozzle plate 35 is fixed to the −Z-direction end surface of the base main body part 51 and the −Z-direction end surface (portions exposed from the module housing part 53) of the jet modules 30A, 30B, and 30C via an adhesive or the like.

The nozzle plate 35 is provided with nozzle holes (not shown) penetrating the nozzle plate 35 in the Z direction. The nozzle holes are independently formed at positions opposed in the Z direction to the respective ejection channels of the head chip.

It should be noted that the nozzle plate 35 is not limited to the resin material. For example, the nozzle plate 35 may also be formed of silicon or a metal material (stainless steel or the like), and may also be provided with a layered structure of the resin material and the metal material. Further, there may be adopted a configuration in which the jet modules 30A, 30B, and 30C are covered with a single nozzle plate 35 in a lump, or a configuration in which the jet modules 30A, 30B, and 30C are individually covered with a plurality of nozzle plates 35.

### Nozzle Guard

The nozzle guard 40 is a metallic member for protecting the nozzle plate 35. The nozzle guard 40 is formed by applying hybrid processing of drawing processing and bending processing to a plate member made of, for example, stainless steel. The nozzle guard 40 covers the base main body part 51 from the −Z direction side in the state of sandwiching the nozzle plate 35 in-between. It should be noted that the frame body 36 (an example of a housing made of resin) formed of synthetic resin such as plastic may be disposed between the nozzle guard 40 and the base member 50.

In the nozzle guard 40, at a position opposed in the Z direction to the −Z-direction end surface of each of the jet modules 30A, 30B, and 30C, there is formed an exposure hole 41h for exposing the nozzle plate 35 to the outside. The exposure hole 41h is formed to have a slit-like shape penetrating the nozzle guard 40 in the Z direction, and extending in the X direction. The exposure holes 41h are formed in three lines at intervals in the Y direction so as to correspond to the respective jet modules 30A, 30B, and 30C. The nozzle holes described above are communicated with the outside of the inkjet head 5A through the exposure holes 41h.

### Conductive Parts

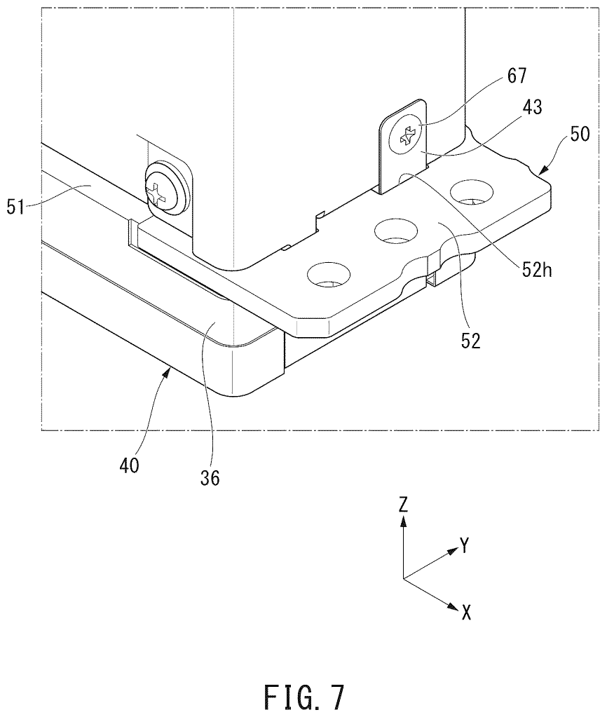

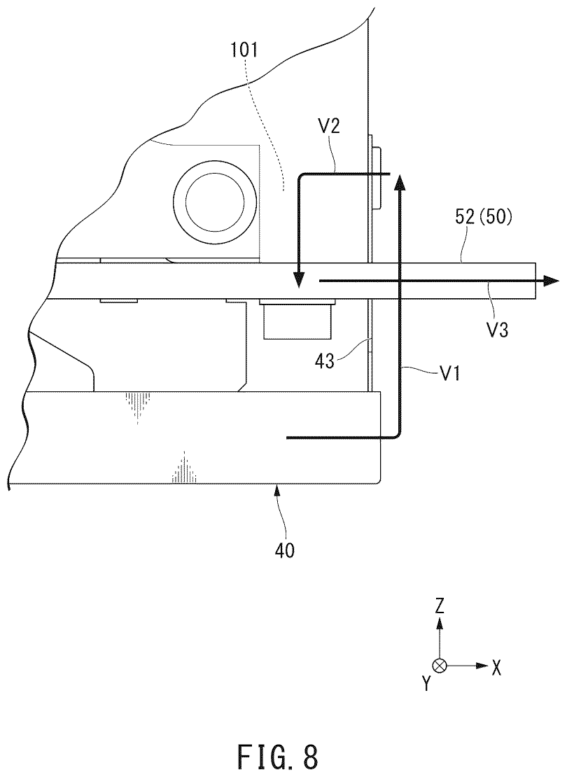

FIG. 7 is an enlarged view of the boxed portion VII in FIG. 2. FIG. 8 is a diagram illustrating a conduction path via the base member 50. In FIG. 8, the illustration of the frame body 36 disposed between the nozzle guard 40 and the base member 50 is omitted.

Referring to FIG. 7 and FIG. 8 in combination, the inkjet head 5A is provided with the base member 50, the jet modules 30A, 30B, and 30C which are mounted on the base member 50 and jet the ink, the nozzle plate 35 provided with the nozzle holes for jetting the ink, the nozzle guard 40 made of metal for protecting the nozzle plate 35, and conductive parts 43 which have conductivity, are electrically coupled to the jet modules 30A, 30B, and 30C and the nozzle guard 40 via the base member 50, and couple the nozzle guard 40 to FG.

The conductive parts 43 are fixed outside the jet modules 30A, 30B, and 30C. Specifically, the conductive parts 43 are each fixed at an outer side in the X direction of an outer end portion in the X direction of the jet modules 30A, 30B, and 30C.

The conductive parts 43 are fixed on a side surface in the longitudinal direction (the X direction) of the jet modules 30A, 30B, and 30C. It should be noted that the conductive parts 43 are not fixed on a side surface in the thickness direction (the Y direction) of the jet modules 30A, 30B, and 30C.

Referring to FIG. 6 in combination, at least corner portions of the nozzle guard 40 have drawn parts 45 to which drawing processing is applied. The nozzle guard 40 is provided with a guard main body part 41 formed to have a plate shape having the thickness direction set to the Z direction, and the longitudinal direction set to the X direction, and an uprise part 42 rising toward the +Z direction from an outer circumferential edge of the guard main body part 41. The drawn parts 45 are disposed at four corner portions of a rectangular shape having the longitudinal direction set to the X direction when viewing the nozzle guard 40 from the Z direction.

The side surface portion of the nozzle guard 40 has a bent part 46 to which the bending processing is applied. The bent part 46 is disposed between a portion (a planar portion) of the uprise part 42 except the corner portions and the guard main body part 41. The uprise part 42 rises toward the +Z direction from each of an outer edge in the X direction and an outer edge in the Y direction of the guard main body part 41 via the bent part 46.

On the boundary between the drawn part 45 and the bent part 46 of the nozzle guard 40, there is formed a cutout 47. The cutout 47 is formed to have a size enough to discharge a liquid which has entered the drawn part 45. The cutouts 47 are formed at four places so as to correspond to the drawn parts 45 disposed at the four corner portions. The cutouts 47 are formed at positions at the inner side in the Y direction of the respective drawn parts 45. The cutouts 47 are each formed longer in the Z direction than in the X direction, and each open in the Y direction.

The conductive part 43 is formed of the same member as, and integrally with, the side surface portion of the nozzle guard 40. In the nozzle guard 40, the side surface portion including the conductive part 43 is formed to have an L-shape when viewed from the X direction. A screw hole 43h which penetrates the conductive part 43 in the X direction is formed in a portion at a +Z-direction end portion side of the conductive part 43.

At both end sides in the X direction of the nozzle guard 40, portions provided with the screw holes 43h of the conductive parts 43 are formed so as to be shifted from each other in the Y direction. The portion provided with the screw hole 43h of the conductive part 43 at the +X-direction end side is formed at a position shifted at the +Y-direction side from the Y-direction central position of the nozzle guard 40. On the other hand, the portion provided with the screw hole 43h of the conductive part 43 at the −X-direction end side is formed at a position shifted at the −Y-direction side from the Y-direction central position of the nozzle guard 40.

Referring to FIG. 7 in combination, the conductive parts 43 are fixed outside the jet modules 30A, 30B, and 30C in portions extending straight from the nozzle guard 40 toward above the base member 50. The base member 50 is provided with an opening part 52h through which the conductive part 43 passes. The opening part 52h penetrates the carriage fixation part 52 in the base member 50 in the Z direction. The opening part 52h is formed to have a slit-like shape extending in the Y direction along the outer circumference of the conductive part 43 when viewed from the Z direction. The conductive part 43 extends straight toward the +Z direction through the opening part 52h provided to the carriage fixation part 52.

The conductive part 43 is fixed with a screw 67. For example, the screw 67 is screwed into an internal thread 65 provided to A −Z-direction end portion of the stay 60 from an X-direction outer side through the screw hole 43h of the conductive part 43. Thus, it is possible to fix the conductive part 43 to the stay 60 with the screw 67.

The conductive parts 43 are fixed to the same member as a grounded portion of the drive board 101 for the jet modules 30A, 30B, and 30C. The grounded portion of the drive board 101 corresponds to, for example, a portion to be the reference ground (a portion functioning as a reference surface of the potential) in the drive board 101. The drive board 101 may be provided with patterned wiring to be the reference ground. In this case, the conductive parts 43 may be coupled to the patterned wiring provided to the drive board 101.

Referring to FIG. 8, in the present embodiment, since there are provided the conductive parts 43 which have conductivity, and are electrically coupled to the jet modules 30A, 30B, and 30C and the nozzle guard 40 via the base member 50 to couple the nozzle guard 40 to FG, a conduction path via the base member 50 is formed.

This conduction path is formed including, for example, a path with the arrow V1 along the conductive part 43 of the nozzle guard 40, a path with the arrow V2 along the grounded portion of the drive board 101, a path with the arrow V3 along the carriage fixation part 52 of the base member 50, and a path (not shown) at an apparatus side passing through the carriage 23 (see FIG. 1).

### Coupling Member

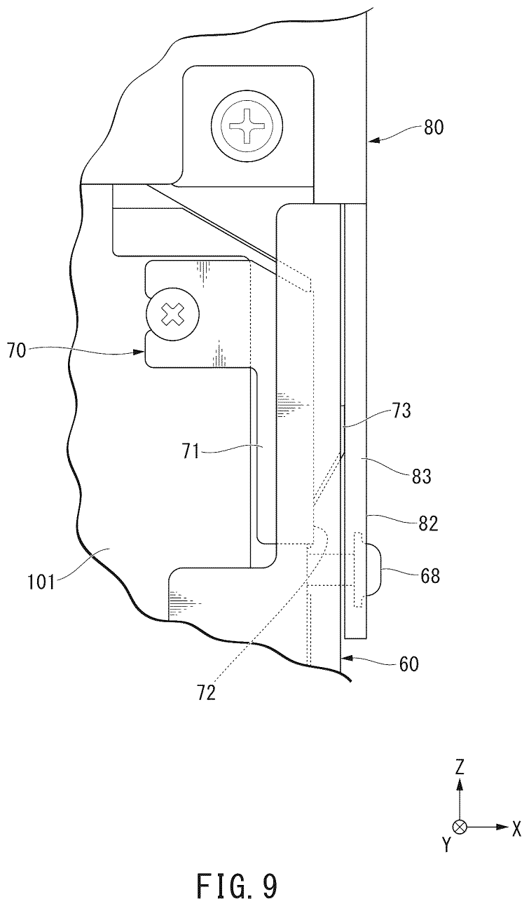

FIG. 9 is a diagram illustrating a conduction path sandwiched by a cover 80 and the stay 60.

Referring to FIG. 3, FIG. 4, and FIG. 9 in combination, the inkjet head 5A is provided with the jet modules 30A, 30B, and 30C which jet the ink, and coupling members 70 having conductivity for coupling the jet modules 30A, 30B, and 30C to FG. At least a part of the coupling member 70 is disposed at an outer side of corresponding one of the jet modules 30A, 30B, and 30C.

The coupling members 70 are fixed outside the jet modules 30A, 30B, and 30C. Specifically, the coupling members 70 are each fixed at an outer side in the X direction of the outer end portions in the X direction of the jet modules 30A, 30B, and 30C.

The coupling members 70 are fixed on a side surface in the longitudinal direction (the X direction) of the jet modules 30A, 30B, and 30C. In the present embodiment, the coupling members 70 are each formed of a plate spring. The coupling member 70 is formed by applying bending processing to a plate member made of, for example, stainless steel.

The coupling member 70 is formed to have a shape in which a portion formed to have an L-shape viewed from the Y direction and a portion formed to have an L-shape viewed from the X direction are integrated with each other. The coupling member 70 is fixed to a +Z-direction end corner portion of a +X-direction end portion in the drive board 101 when viewed from the −Y direction with a screw or the like. The three coupling members 70 are provided so as to correspond to the respective jet modules 30A, 30B, and 30C. The coupling members 70 are formed of the same configuration, and are arranged side by side in the Y direction.

Specifically, the coupling members 70 are each provided with a first extending portion 71 which extends from a fixation portion with the drive board 101 toward the outer side in the +X direction beyond the +X-direction outer end edge of the drive board 101, and then extends in the −Z direction, a second extending portion 72 which extends in the +Y direction from the −Z-direction end portion of the first extending portion 71 to a position opposed to the +X-direction end surface of corresponding one of the jet modules 30A, 30B, and 30C, and a third extending portion 73 which extends obliquely toward the +X direction and the +Z direction from the +Y-direction end portion of the second extending portion 72, and then extends straight toward the +Z direction. Each of the coupling members 70 is configured to apply biasing force in at least the X direction between corresponding one of the jet modules 30A, 30B, and 30C and a holding portion 83.

The stay 60 is disposed outside the jet modules 30A, 30B, and 30C. A part of the coupling member 70 protrudes to the outside of the stay 60. The stay 60 is provided with an opening part 61h through which the coupling members 70 pass. An internal thread 66 is formed at the −Z direction side of the opening part 61h of a stay main body part 61.

Specifically, the stay 60 is provided with the stay main body part 61 formed to have a plate shape having the thickness direction set to the X direction, and the longitudinal direction set to the Z direction, and projecting portions 62 projecting from both outer end edges in the Y direction of the stay main body part 61 toward an inner side in the X direction. The stay main body part 61 is provided with the opening part 61h for drawing out a part (a portion at the X-direction outer end side of the third extending portion 73) of the coupling member 70 to the +X direction side beyond the stay main body part 61. The opening part 61h is formed to have a slit-like shape penetrating the stay main body part 61 in the X direction, and extending in the Y direction. A part of each of the coupling members 70 protrudes toward the +X direction side beyond the stay main body part 61 through the opening part 61h. The internal threads 66 are formed as a pair at an interval in the Y direction.

The inkjet head 5A is provided with the holding portion 83 which holds portions of the coupling members 70 protruding outside the stay 60 by clamping the portions with the stay 60. The portion of each of the coupling members 70 protruding outside the stay 60 is clamped between the holding portion 83 and the stay 60.

The inkjet head 5A is provided with the cover 80 which covers the jet modules 30A, 30B, and 30C and the stay 60. The holding portion 83 forms a part of the cover 80.

The cover 80 is formed to have a shape opening in the −Z direction, and covers the upper side of the jet modules 30A, 30B, and 30C and so on from the +Z direction. Specifically, the cover 80 is provided with a cover main body part 81 formed to have a box-like shape having the longitudinal direction set to the X direction, and opening in the −Z direction, and extending portions 82 which extend in the −Z direction from both outer end portions in the X direction of the cover main body part 81.

The cover main body part 81 is provided with through holes for exposing a port for the ink to inflow, connectors, and so on to the +Z direction, and so on. A part of the extending portion 82 is formed of the holding portion 83. A screw hole 82h which penetrates the extending portion 82 in the X direction is provided to a portion at the −Z-direction end portion side of each of the extending portions 82. The screw holes 82h are formed as a pair at an interval in the Y direction. The screw hole 82h is formed at a position corresponding to the internal thread 66 (a position overlapping the internal thread 66 when viewed from the X direction in an assembled state of the cover 80).

The coupling members 70 are fixed with screws 68. For example, in the state in which a part of each of the coupling members 70 protrudes outside the stay 60, the screws 68 are screwed into the internal threads 66 of the stay main body part 61 from the outer side in the X direction through the screw holes 82h of the cover 80, respectively. Thus, it is possible to fix the extending portions 82 to the stay 60 with the screws 68, and at the same time, clamp the portion of each of the coupling members 70 protruding outside the stay 60 between the stay 60 and the holding portion 83 to hold the portion. In the present embodiment, it is possible to hold the portions of the respective coupling members 70 protruding outside the stay 60 with the holding portion 83 of the cover 80 in a lump.

Referring to FIG. 9, in the present embodiment, since the coupling members 70 which have conductivity and are for coupling the jet modules 30A, 30B, and 30C to FG are provided, the holding portion 83 for holding the portions of the coupling members 70 protruding outside the stay 60 by clamping the portions with the stay 60 is provided, and the holding portion 83 forms a part of the cover 80, the conduction path sandwiched by the cover 80 and the stay 60 is formed.

### Operation Method of Printer

A method of recording information on the recording target medium P using the printer 1 described above will be described.

As shown in FIG. 1, when operating the printer 1, the grit rollers 11, 13 of the conveyance mechanisms 2, 3 rotate to thereby convey the recording target medium P between the grit rollers 11, 13 and the pinch rollers 12, 14 in the +X direction. Further, at the same time as this operation, the drive motor 28 rotates the pulley 26 to run the endless belt 27. Thus, the carriage 23 reciprocates in the Y direction while being guided by the guide rails 21, 22.

Meanwhile, in the inkjet heads 5A, 5B, the drive voltages are applied to the respective drive electrodes of the head chips. Thus, the thickness shear deformation is caused in the drive wall, and thus, the pressure wave is generated in the ink filling the ejection channel. Due to the pressure wave, the internal pressure of the ejection channel increases, and the ink is ejected through the nozzle hole. Further, by the ink landing on the recording target medium P, a variety of types of information are recorded on the recording target medium P.

### Functions and Advantages

The inkjet heads 5A, 5B are each provided with the base member 50, the jet modules 30A, 30B, and 30C which are mounted on the base member 50 and jet the ink, the nozzle plate 35 provided with the nozzle holes for jetting the ink, the nozzle guard 40 made of metal for protecting the nozzle plate 35, and the conductive parts 43 which have conductivity, are electrically coupled to the jet modules 30A, 30B, and 30C and the nozzle guard 40 via the base member 50, and couple the nozzle guard 40 to FG.

According to this configuration, it is possible to short the nozzle guard 40 to make the nozzle guard 40 the same in potential as FG so as to prevent the static electricity from the medium from hitting the electrodes and so on through the nozzle holes. Therefore, it is possible to prevent the damage of the inkjet heads 5A, 5B from the static electricity.

The conductive parts 43 in the present embodiment are fixed outside the jet modules 30A, 30B, and 30C.

According to this configuration, the fixation work can be performed outside the jet modules 30A, 30B, and 30C, which, therefore, makes a contribution to an improvement of the workability.

The conductive parts 43 in the present embodiment are fixed on the side surfaces in the longitudinal direction of the jet modules 30A, 30B, and 30C.

According to this configuration, since there is no influence in the thickness direction of the inkjet heads 5A, 5B, density growth can be achieved even when disposing a plurality of inkjet heads 5A, 5B in the thickness direction.

The conductive parts 43 in the present embodiment are fixed with the screws 67.

According to this configuration, since screw fixation is adopted, the electrical coupling can more reliably be achieved.

The conductive parts 43 in the present embodiment are fixed to the same member as the grounded portion of the drive board 101 for the jet modules 30A, 30B, and 30C.

According to this configuration, the potential can reliably be made the same as that of the drive board 101 without intervention of any other members due to the commonalization of the grounded portion. In addition, noise suppression effect is obtained.

The base member 50 in the present embodiment is provided with the opening parts 52h through which the conductive parts 43 pass.

According to this configuration, the jet modules 30A, 30B, and 30C and the nozzle guard 40 can electrically be coupled through the opening parts 52h of the base member 50, which, therefore, makes a contribution to shortening of the conduction path. Further, even when the base member 50 is partially made of a nonmetallic material, the nozzle guard 40 can be made the same in potential as FG.

At least corner portions of the nozzle guard 40 in the present embodiment have the drawn parts 45 to which drawing processing is applied.

According to this configuration, it is possible to prevent a gap from being formed in at least the corner portions of the nozzle guard 40.

The side surface portion of the nozzle guard 40 in the present embodiment has the bent part 46 to which the bending processing is applied.

According to this configuration, even the portion which cannot be provided with enough length by the drawing processing alone can be stretched long enough by the bending processing, and therefore, it becomes possible to achieve the conduction with the side surface portion.

On the boundary between the drawn part 45 and the bent part 46 of the nozzle guard 40 in the present embodiment, there is formed the cutout 47.

According to this configuration, it is possible to discharge the liquid which has entered the drawn part 45 through the cutouts 47 of the nozzle guard 40. In addition, even when the nozzle guard 40 is made by the hybrid processing of the drawing processing and the bending processing, the cutouts 47 make the processing easy.

The conductive part 43 in the present embodiment is formed of the same member as, and integrally with, the side surface portion of the nozzle guard 40.

According to this configuration, no dedicated conduction component is required, which makes a contribution to a reduction in the number of components.

The conductive parts 43 in the present embodiment are fixed outside the jet modules 30A, 30B, and 30C in the portions extending straight from the nozzle guard 40 toward above the base member 50.

According to this configuration, it becomes possible to reduce the space in the installation surface direction compared to when disposing, for the fixation, a widened portion extending in the installation surface direction of the inkjet heads 5A, 5B. Further, a housing made of resin can be disposed between the nozzle guard 40 and the base member 50, which, therefore, makes a contribution to the reduction in cost compared to when disposing a metallic housing.

The printer 1 according to the present embodiment is provided with the inkjet heads 5A, 5B described above.

According to this configuration, it is possible to obtain the printer 1 capable of preventing the damage of the inkjet heads 5A, 5B from the static electricity.

Incidentally, when a cover component for protecting the nozzle plate is made of metal having conductivity, and is not electrically coupled to other components, it is preferable for the cover component to be made the same in potential as FG on the following grounds.
(1) The nozzle guard is shorted to be grounded so that the static electricity from the medium does not hit the electrodes (e.g., a common electrode) and so on through the nozzle holes.
(2) A return current path (a path from the nozzle guard to the drive board) of the noise generated during driving is made the shortest so that the noise does not have a harmful influence.
(3) In order to prevent metal corrosion due to a potential difference between the nozzle guard and the electrodes (e.g., the common electrode) when these are coupled to each other via the ink, the nozzle guard is prevented from electrically floating.

In the present embodiment described above, there are provided the conductive parts 43 which are electrically coupled to the jet modules 30A, 30B, and 30C and the nozzle guard 40 via the base member 50, and are for coupling the nozzle guard 40 to FG, and the conductive parts 43 are fixed outside the jet modules 30A, 30B, and 30C in the portions extending straight from the nozzle guard 40 toward above the base member 50. Thus, (A) it is possible to prevent the damage of the inkjet heads 5A, 5B from the static electricity, (B) it is possible to reduce the influence of the noise during printing, and (C) it is possible to prevent the metal corrosion of the nozzle guard 40. Further, (D) the reduction in space in the installation surface direction becomes possible, and thus, the size of the carriage 23 can be reduced, which makes a contribution to a reduction in size of the apparatus, and a reduction in cost of the conveyance system. Further, (E) it becomes possible to achieve the advantages (A) to (D) described above while keeping the strength of the inkjet heads 5A, 5B.

The inkjet heads 5A, 5B according to the present embodiment are each provided with the jet modules 30A, 30B, and 30C which jet the ink, and the coupling members 70 having conductivity for coupling the jet modules 30A, 30B, and 30C to FG. At least a part of the coupling member 70 is disposed at an outer side of corresponding one of the jet modules 30A, 30B, and 30C.

For example, when the whole of the coupling member for coupling the jet module to FG is disposed inside the jet module, it becomes difficult to visually confirm the FG coupling at the time of assembling. In contrast, according to this configuration, since at least a part of the coupling member 70 is disposed at the outer side of the jet modules 30A, 30B, and 30C, it is easy to visually confirm the FG coupling at the time of assembling. Further, it is easy to confirm the conduction even after assembling.

The coupling members 70 in the present embodiment are fixed outside the jet modules 30A, 30B, and 30C.

According to this configuration, the fixation work can be performed outside the jet modules 30A, 30B, and 30C, which, therefore, makes a contribution to an improvement of the workability.

The coupling members 70 in the present embodiment are fixed on the side surfaces in the longitudinal direction of the jet modules 30A, 30B, and 30C.

According to this configuration, since there is no influence in the thickness direction of the jet modules 30A, 30B, and 30C, density growth can be achieved even when disposing a plurality of jet modules 30A, 30B, and 30C in the thickness direction.

The coupling members 70 in the present embodiment are fixed with the screws 68.

According to this configuration, since screw fixation is adopted, the electrical coupling can more reliably be achieved.

The inkjet heads 5A, 5B in the present embodiment are each provided with the stay 60 to be disposed outside the jet modules 30A, 30B, and 30C. A part of the coupling member 70 protrudes outside the stay 60.

According to this configuration, since a part of the coupling member 70 protrudes outside the stay 60, it is easy to visually confirm the FG coupling at the time of assembling.

The inkjet heads 5A, 5B according to the present embodiment are each provided with the holding portion 83 which holds the portions of the coupling members 70 protruding outside the stay 60 by clamping the portions with the stay 60.

According to this configuration, the fixation is achieved by the clamping with the stay 60 and the holding portion 83, which, therefore, makes a contribution to an improvement in reliability of the electrical coupling.

The stay 60 in the present embodiment is provided with the opening part 61h through which the coupling members 70 pass.

According to this configuration, it is possible to draw a part of the coupling member 70 out of the stay 60 through the opening part 61h of the stay 60.

The inkjet heads 5A, 5B according to the present embodiment are each provided with the cover 80 which covers the jet modules 30A, 30B, and 30C and the stay 60. The holding portion 83 forms a part of the cover 80.

According to this configuration, since the fixation is achieved by the clamping with a part of the cover 80 and the stay 60, no dedicated fixation component is required, which makes a contribution to a reduction in the number of components.

The printer 1 according to the present embodiment is provided with the inkjet heads 5A, 5B described above.

According to this configuration, it is possible to obtain the printer 1 which is easy to visually confirm the FG coupling at the time of assembling, and is easy to confirm the conduction even after assembling.

Incidentally, in industrial-use inkjet printers, since the ink is jetted, the surface of the medium is charged, and therefore, there is a possibility that electrostatic discharge occurs in the inkjet heads. Further, when driving the actuators used in the inkjet heads, a loud drive noise may be generated in some cases. In this case, there is also a possibility that the drive noise incurs some erroneous operations of other inkjet heads inside the inkjet printer. The configurations disclosed in PTLA (JP2006-68981A) and PTLB (JP6504889B) exist in order to avoid the above.

PTLA discloses a liquid jet head including a head unit including a flow path unit provided with a liquid flow path, a nozzle plate having conductivity and bonded to the head unit, a head case to which the nozzle plate and the head unit are fixed, a head cover having conductivity and attached to the head case so as to enclose the nozzle plate and the head unit from the outside. The head cover includes a frame part provided with an opening part for exposing the nozzle plate, and a contact protrusion protruding inward from an inner circumferential edge of the frame part. The head cover is attached to the head case in a state in which the contact protrusion has contact with an outer circumferential edge of the nozzle plate.

PTLB discloses a configuration including a main body, an ejection unit capable of ejecting a liquid supplied through a liquid flow path, an electrical wiring board provided with a contact point part for receiving a signal from the outside, a flow path formation member which forms the liquid flow path, and a plate spring having conductivity and electrically coupled to the contact point part. In PTLB, contact pressure necessary for the electrical contact between the plate spring and the contact point part is ensured by an elastic deformation of the plate spring.

However, in the case of the configuration in PTLA, since the contact protrusion is disposed inside the head cover, it is difficult to visually confirm whether the contact protrusion has contact with the nozzle plate when viewed from the outside of the head cover. In the case of the configuration in PTLB, it is difficult to visually confirm whether the plate spring and the contact point part have contact with each other when viewed from the outside of the main body. Further, when the whole of a coupling member for coupling the main body to a frame ground is disposed inside the main body, it becomes difficult to visually confirm the frame ground coupling at the time of assembling. Further, when it is attempted to ensure the electrical coupling only with the elastic restorative force of the plate spring, there is a concern that the coupling becomes unstable due to the vibration at the time of transportation and the vibration of the apparatus.

In contrast to the above, in the present embodiment, there are provided the coupling members 70 which have conductivity, and are for coupling the jet modules 30A, 30B, and 30C to FG, the stay 60 disposed outside the jet modules 30A, 30B, and 30C, and the cover 80 which covers the jet modules 30A, 30B, and 30C and the stay 60, a part of each of the coupling members 70 protrudes outside the stay 60, and the cover 80 is provided with the holding portion 83 which clamps the portions of the coupling members 70 protruding outside the stay 60 with the stay 60 to thereby hold the portions. Thus, (A) it is easy to visually confirm the FG coupling at the time of assembling since a part of the coupling member 70 protrudes outside the stay 60, and (B) the part of the coupling member 70 is fixed by the clamping with the stay 60 and the holding portion 83 of the cover 80, which, therefore, makes a contribution to the improvement of the reliability of the electrical coupling. Further, (C) it is possible to achieve robustness against external factors such as an apparatus vibration due to the fixation with the clamping described above. Further, (D) when three or more jet modules 30A, 30B, and 30C are installed, it is easy to achieve the FG coupling of the jet module (e.g., the jet module 30B) disposed at the center side among them.

### Modified Examples

It should be noted that the scope of the invention is not limited to the embodiments described above, but a variety of modifications can be applied within the scope or the spirit of the invention.

In the embodiment described above, there is explained the configuration in which the conductive parts are fixed outside the jet modules, but this configuration is not a limitation. For example, the conductive parts may be fixed inside the jet modules.

In the embodiment described above, there is explained the configuration in which the conductive parts are fixed on the side surface in the longitudinal direction of the jet module, but this configuration is not a limitation. For example, the conductive parts may be fixed on the side surface in the thickness direction of the jet module.

In the embodiment described above, there is explained the configuration in which the conductive parts are fixed with the screws, but this configuration is not a limitation. For example, the conductive parts may be fixed via a biasing member such as a spring, or may be fixed with an electrically-conductive adhesive or the like.

In the embodiment described above, there is explained the configuration in which the conductive parts are fixed to the same member as the grounded portion of the drive board for the jet module, but this configuration is not a limitation. For example, the conductive parts may be fixed to a different member (via a different member) from the grounded portion of the drive board for the jet module. The fixation configuration of the conductive parts can be changed in accordance with the design specification.

In the embodiment described above, there is explained the configuration in which the base member is provided with the opening part through which the conductive parts pass, but this configuration is not a limitation. For example, there may be adopted a configuration in which the base member is not provided with the opening part, and the conductive parts extend so as to bypass the base member to electrically couple the jet modules and the nozzle guard. The formation configuration of the opening part in the base member and/or the configuration of the extension of the conductive parts can be changed in accordance with the design specification.

In the embodiment described above, there is explained the configuration in which at least the corner portions of the nozzle guard have the drawn parts to which the drawing processing is applied, but this configuration is not a limitation. For example, the corner portions of the nozzle guard may have the bent parts to which the bending processing is applied.

In the embodiment described above, there is explained the configuration in which the side surface portion of the nozzle guard has the bent part to which the bending processing is applied, but this configuration is not a limitation. For example, the side surface portion of the nozzle guard may have a drawn part to which the drawing processing is applied. The configuration of the drawn part and/or the bent part can be changed in accordance with the design specification.

In the embodiment described above, there is explained the configuration in which the cutout is formed on the boundary between the drawn part and the bent part of the nozzle guard, but this configuration is not a limitation. For example, on the boundary between the drawn part and the bent part of the nozzle guard, there may be disposed a buried part for filling a gap on the boundary. The formation configuration of the cutout can be changed in accordance with the design specification.

In the embodiment described above, there is explained the configuration in which the conductive part is formed of the same member as, and integrally with, the side surface portion of the nozzle guard, but this configuration is not a limitation. For example, the conductive part may be formed of a different member from the side surface portion of the nozzle guard, and may be integrally coupled to the side surface portion of the nozzle guard. For example, the conductive part may be formed of the same member as, and integrally with, the side surface portion of the stay. The formation configuration of the conductive parts can be changed in accordance with the design specification.

In the embodiment described above, there is explained the configuration in which the conductive parts are fixed outside the jet modules in the portion extending straight from the nozzle guard toward above the base member, but this configuration is not a limitation. For example, the widened portion extending in the installation surface direction of the inkjet heads may be disposed for the fixation.

In the embodiment described above, there is explained the configuration in which the coupling members are fixed outside the jet modules, but this configuration is not a limitation. For example, the coupling members may be fixed inside the jet modules.

In the embodiment described above, there is explained the configuration in which the coupling members are fixed on the side surface in the longitudinal direction of the jet module, but this configuration is not a limitation. For example, the coupling members may be fixed on the side surface in the thickness direction of the jet module.

In the embodiment described above, there is explained the configuration in which the coupling members are fixed with the screws, but this configuration is not a limitation. For example, the coupling members may be fixed via a biasing member such as a spring, or may be fixed with an electrically-conductive adhesive or the like.

In the embodiment described above, there is explained the configuration in which the inkjet head is provided with the stay disposed outside the jet module, and a part of the coupling member protrudes outside the stay, but this configuration is not a limitation. For example, the whole of the coupling members may be disposed inside the stay. For example, the stay is not required to be disposed outside the jet modules. The installation configuration of the stay and/or the arrangement configuration of the coupling members can be changed in accordance with the design specification.

In the embodiment described above, there is explained the configuration in which the inkjet head is provided with the holding portion which holds the portions of the coupling members protruding outside the stay by clamping the portions with the stay, but this configuration is not a limitation. For example, the portions of the coupling members protruding outside the stay may be fixed only to the stay. For example, the holding portion for holding the portions of the coupling members protruding outside the stay is not required to be provided. The fixation configuration of the coupling members and/or the installation configuration of the holding portion can be changed in accordance with the design specification.

In the embodiment described above, there is explained the configuration in which the stay is provided with the opening part through which the coupling members pass, but this configuration is not a limitation. For example, there may be adopted a configuration in which the stay is not provided with the opening part, and a part of the coupling member extends so as to bypass the stay to go outside the stay. The formation configuration of the opening part in the stay and/or the configuration of the extension of the coupling members can be changed in accordance with the design specification.

In the embodiment described above, there is explained the configuration in which the inkjet head is provided with the cover which covers the jet modules and the stay, and the holding portion forms a part of the cover, but this configuration is not a limitation. For example, the holding portion may be formed of a separate member from the cover. For example, the cover which covers the jet modules and the stay is not required to be disposed. The installation configuration of the cover and/or the configuration of the holding portion can be changed in accordance with the design specification.

### Second Embodiment

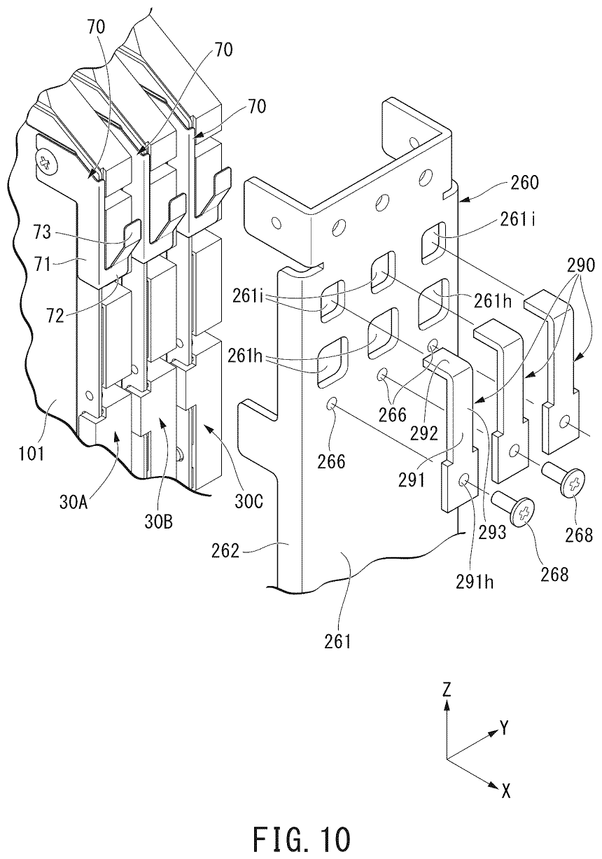

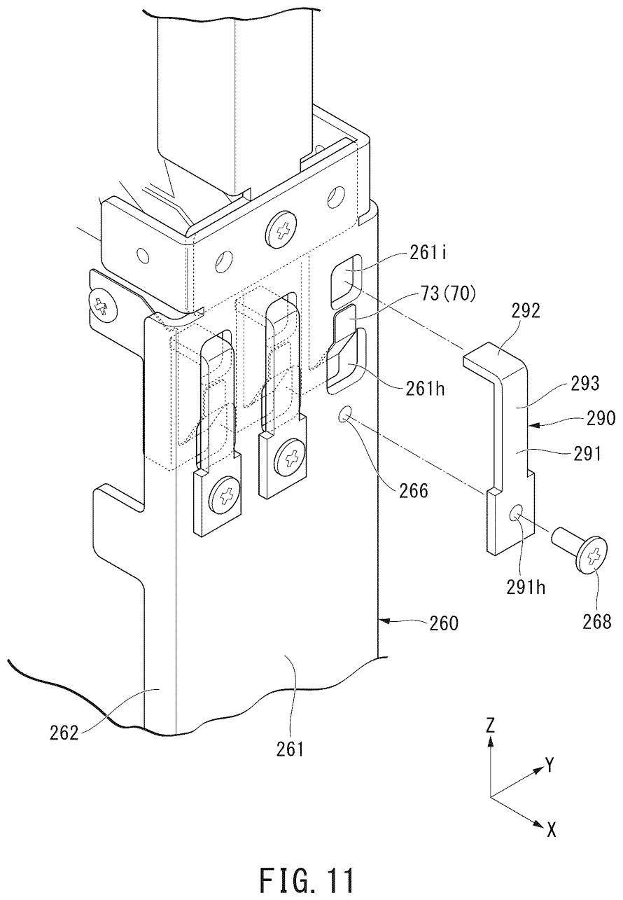

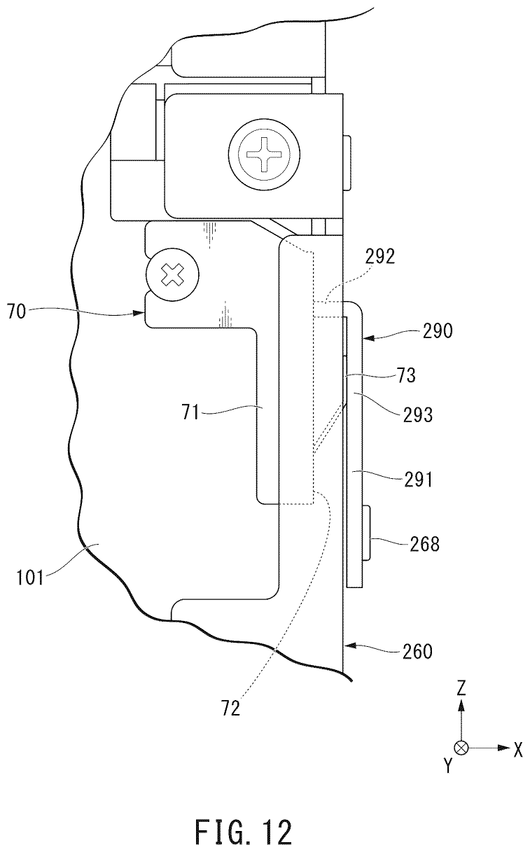

FIG. 10 is a partially exploded perspective view of the inkjet head. FIG. 11 is a perspective view showing an attachment portion of a stay 260 and a plate member 290. FIG. 12 is a diagram illustrating a conduction path sandwiched by the plate member 290 and the stay 260.

In the first embodiment described above, the description is presented citing the example in which the conduction path sandwiched by the cover 80 and the stay 60 is formed, but this example is not a limitation. For example, as shown in FIG. 12, the conduction path sandwiched by the plate member 290 and the stay 260 may be formed. In the second embodiment, substantially the same constituents as those of the embodiment described above are denoted by the same reference symbols, and the detailed description thereof will be omitted.

Referring to FIG. 10 to FIG. 12 in combination, the stay 260 is disposed outside the jet modules. A part of the coupling member 70 protrudes to the outside of the stay 260. The stay 260 is provided with opening parts 261h through which the coupling members 70 pass.

The stay 260 is provided with a stay main body part 261 formed to have a plate shape having the thickness direction set to the X direction, and the longitudinal direction set to the Z direction, and projecting portions 262 projecting from both outer end edges in the Y direction of the stay main body part 261 toward an inner side in the X direction. The stay main body part 261 is provided with the opening parts 261h each for drawing out a part (a portion at the X-direction outer end side of the third extending portion 73) of each of the coupling members 70 to the +X direction side beyond the stay main body part 261. Each of the opening parts 261h is formed to penetrate the stay main body part 261 in the X direction, and have a rectangular shape having rounded corners when viewed from the X direction. A part of each of the coupling members 70 protrudes toward the +X direction side beyond the stay main body part 261 through corresponding one of the opening parts 261h.

The inkjet head is provided with holding portions 293 which hold respective portions of the coupling members 70 protruding outside the stay 260 by clamping the portions with the stay 260. The portion of each of the coupling members 70 protruding outside the stay 260 is clamped between the holding portion 293 and the stay 260.

The inkjet head is provided with the plate members 290 each having the holding portion 293. The holding portion 293 forms a part of the plate member 290. The holding portion 293 is formed in a portion at the +Z-direction end side of the plate member 290.

The three plate members 290 are disposed at intervals in the Y direction so as to correspond to the respective coupling members 70. The plate members 290 are each formed to have an L-shape having the longitudinal direction set to the Z direction. Specifically, the plate members 290 are each provided with a plate main body part 291 formed to have a plate shape having the thickness direction set to the X direction, and the longitudinal direction set to the Z direction, and a projecting portion 292 projecting from the +Z-direction end portion of the plate main body part 291 toward the −X direction.

A part of the plate main body part 291 is formed of the holding portion 293. The holding portion 293 is formed in a portion at the +Z-direction end side of the plate main body part 291. A screw hole 291h which penetrates the plate main body part 291 in the X direction is provided to a portion at the −Z-direction end portion side of the plate main body part 291. The portion provided with the screw hole 291h is widened in the Y direction compared to a portion at the +Z direction side of the plate main body part 291.

The stay main body part 261 is provided with through holes 261i in a region at the +Z direction side of the respective opening parts 261h, wherein the through holes 261i each allows the projecting portion 292 of the plate member 290 to protrude toward the −X direction side beyond the stay main body part 261. Each of the through holes 261i is formed to penetrate the stay main body part 261 in the X direction, and have a rectangular shape having rounded corners when viewed from the X direction. Each of the through holes 261i is formed smaller in size than each of the opening parts 261h.

Internal threads 266 are formed at the −Z direction side of the respective opening parts 261h of the stay 260. The internal thread 266 is arranged on a Z direction line passing through the Y-direction central position of each of the opening parts 261h, and the three internal threads 266 are formed at intervals in the Y direction.

The coupling members 70 are fixed with screws 268. For example, in the state in which a part of each of the coupling members 70 protrudes outside the stay 260, the screws 268 are screwed into the internal threads 266 of the stay 260 from the outer side in the X direction through the screw holes 291h of the plate main body parts 291, respectively. Thus, it is possible to fix the plate main body parts 291 to the stay 260 with the screws 268, and at the same time, clamp the portion of each of the coupling members 70 protruding outside the stay 260 between the stay 260 and the holding portion 293 to hold the portion. In the present embodiment, it is possible to individually hold the portions of the respective coupling members 70 protruding outside the stay 260 with the holding portions 293 of the respective plate members 290 and the stay 260.

Referring to FIG. 12, in the present embodiment, since the coupling members 70 which have conductivity and are for coupling the jet modules to FG are provided, the holding portions 293 for holding the portions of the coupling members 70 protruding outside the stay 260 by clamping the portions with the stay 260 are provided, and the holding portions 293 each form a part of the plate member 290, the conduction path sandwiched by the plate member 290 and the stay 260 is formed.

The inkjet head according to the present embodiment is provided with the plate members 290 each having the holding portion 293.

According to this configuration, it is possible to more reliably achieve the conduction compared to when fixing the coupling members 70 directly with the screws.

### Other Modified Examples

It should be noted that the scope of the present disclosure is not limited to the embodiments described above, but a variety of modifications can be applied within the scope or the spirit of the present disclosure.

For example, in the embodiment described above, the description is presented citing the inkjet printer as an example of the liquid jet recording apparatus, but the liquid jet recording apparatus is not limited to the printer. For example, the liquid jet recording apparatus can be a facsimile machine, an on-demand printing machine, and so on.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiment described above, there is described when the recording target medium is paper, but this configuration is not a limitation. The recording target medium is not limited to paper, but can also be a metal material or a resin material, and can also be food or the like.

In the embodiments described above, there is explained the configuration in which the liquid jet heads are installed in the liquid jet recording apparatus, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiment described above, there is described the configuration in which the Z direction coincides with the gravitational direction, but this configuration is not a limitation. For example, the Z direction can be made coincide with a horizontal direction.

In the embodiments described above, there is explained the configuration in which the three jet modules are mounted on the base member, but this configuration is not a limitation. The number of jet modules mounted on the base member may also be one, two, or a plural number equal to or greater than four.

In the embodiments described above, the jet modules (the head chips) of an edge shoot type are described, but this is not a limitation. For example, it is also possible to apply the invention to a head chip of a so-called side shoot type for ejecting the ink from a central part in the extending direction in the ejection channel.

Further, it is also possible to apply the invention to a head chip of a so-called roof shoot type in which the direction of the pressure applied to the ink and the ejection direction of the ink are made to coincide with each other.

In the embodiments described above, there is explained the configuration in which the inkjet head is provided with the jet modules for jetting the liquid and the coupling members having conductivity for coupling the jet modules to FG, and at least a part of the coupling member is disposed outside the jet modules, but this configuration is not a limitation. For example, the whole of the coupling members may be disposed inside the jet modules. For example, the coupling members having conductivity for coupling the jet modules to FG are not required to be provided. The installation formation of the coupling members can be changed in accordance with the design specification. That is, it is sufficient for the liquid jet head according to an aspect of the present disclosure to be provided with the base member, the jet modules which are mounted on the base member, and jet the liquid, the nozzle plate provided with the nozzle holes for jetting the liquid, the nozzle guard which is made of metal and protects the nozzle plate, and the conductive parts which have conductivity, are electrically coupled to the jet modules and the nozzle guard via the base member, and couple the nozzle guard to the frame ground.

Besides the above, it is arbitrarily possible to replace the constituents in the embodiment described above with known constituents within the scope or the spirit of the invention, and it is also possible to arbitrarily combine the modified examples described above.

Although the preferred embodiments of the present disclosure and the modified examples are hereinabove described, it should be understood that these are illustrative descriptions of the present disclosure, and should not be considered as a limitation. Modification such as addition, omission, and displacement can be implemented within the scope or the spirit of the present disclosure. Therefore, the present disclosure should not be assumed to be limited by the above description, but is limited by the appended claims.

What is claimed is:

1. A liquid jet head comprising:
a base member;
a jet module mounted on the base member and configured to jet a liquid;
a nozzle plate provided with a nozzle hole configured to jet the liquid;
a nozzle guard made of metal and configured to protect the nozzle plate; and
a conductive part which has conductivity, which is electrically coupled to the jet module and the nozzle guard via the base member, and which is configured to couple the nozzle guard to a frame ground.

2. The liquid jet head according to claim 1, wherein the conductive part is fixed outside the jet module.

3. The liquid jet head according to claim 2, wherein the conductive part is fixed on a side surface in a longitudinal direction of the jet module.

4. The liquid jet head according to claim 1, wherein the conductive part is fixed with a screw.

5. The liquid jet head according to claim 1, wherein the conductive part is fixed to a same member as a grounded portion of a drive board for the jet module.

6. The liquid jet head according to claim 1, wherein the base member is provided with an opening part through which the conductive part passes.

7. The liquid jet head according to claim 1, wherein at least a corner portion of the nozzle guard includes a drawn part to which drawing processing is applied.

8. The liquid jet head according to claim 7, wherein a side surface portion of the nozzle guard has a bent part to which bending processing is applied.

9. The liquid jet head according to claim 8, wherein a cutout is formed on a boundary between the drawn part and the bent part of the nozzle guard.

10. The liquid jet head according to claim 8, wherein the conductive part is formed of a same member as, and integrally with, the side surface portion of the nozzle guard.

11. The liquid jet head according to claim 10, wherein the conductive part is fixed outside the jet module in a portion extending straight from the nozzle guard toward above the base member.

12. A liquid jet recording apparatus comprising the liquid jet head according to claim 1.
